(19) United States
(12) Patent Application Publication
(10) Pub. No.: US 2003/0188666 A1
(43) Pub. Date: Oct. 9, 2003

(54) Grout for earth heat exchange systems

(76) Inventors: Howard E. Johnson JR., Kennesaw, GA (US); Ernest E. Carter JR., Sugarland, TX (US)

Correspondence Address: Guy McClung, Suite 347, 16690 Champion Forest Drive, Spring, TX, 77379-7023, US

(21) Appl. No.: 10/119,246

(22) Filed: Apr. 9, 2002

(51) Int. Cl. C04B 7/00

(52) U.S. Cl. 106/638

(57) ABSTRACT

A grout for use in a borehole of an earth energy transfer system between the exterior of an earth loop in the borehole and an interior wall of the borehole, the system having an energy transfer fluid moving through the loop for transferring energy with respect to the earth, the grout having, in certain aspects, sand, cement, the cement present in particles, water, and, optionally, cement setting retardant material, bentonite, material creating a repelling electrostatic charge on cement particles for reducing friction of the grout, and/or friction reducing material.

### BACKGROUND OF THE INVENTION

1. Field of the Invention

The present invention is directed to underground heat exchange systems; to apparatus and methods for installing such systems; and to thermally conductive grout for emplacement between pipe loop(s) of such systems and an interior hole wall.

2. Description of Related Art

In many typical known earth loop energy transfer system, heat is exchanged with the earth using a closed loop pipe or series of closed loop pipes buried in the ground. A heat exchange fluid is circulated through this buried pipe system. This fluid is not in direct contact with the earth. If a difference exists between the temperature of the fluid circulating in the pipe and the earth temperature, an exchange of heat occurs—primarily by conduction through the wall of the pipe. In certain systems if the system is operating in the heating mode, heat is taken from the fluid inside of this circulating loop by a heat exchanger in heat pump equipment. As relatively cool water (e.g. 35° F.) is circulated back through relatively warm earth (e.g. 65° F.), heat is transferred into the fluid, which is subsequently taken from this stream as it continues to circulate through the heat pump's heat exchanger. Similarly, if the system is operating in a cooling mode, the heat pump's heat exchanger puts heat into this circulating fluid. Then, as relatively warm fluid (e.g. 100° F.) is circulated through the relatively cool earth (e.g. 65° F.), heat is given up to the earth and the relatively cool fluid is circulated back to the heat pump to absorb more heat—and the process is continued. Because of its mass, the earth stays at a relatively constant temperature, providing an almost limitless resource as a heat supplier and heat sink.

The prior art discloses a wide variety of earth heat exchange systems and methods for using energy transferred by such systems. The prior art discloses the use of various filler materials, including, but not limited to, a common grout, typically a bentonite clay mixture, for use as a thermally conductive material between a pipe loop of an underground heat exchange system and the interior of a hole in which the loop is positioned. The grouts and filler materials of the prior art are used in an effort to provide some structural support to the system in the ground; to provide a highly thermally conductive connection between the heat transfer pipes and the earth; to prevent contaminated surface waters from migrating down the wellbore to a potable water aquifer; and to prevent cross-communication between different aquifers in the same borehole.

An ideal grout material would be: at least as thermally conductive as the native earth; be easily and reliably placed in the borehole; maintain conductivity “long term”; and be inexpensive. Many conductive high solids and cementitious “grouts” have been developed which include a mixture of water and a relatively conductive solid such as silica sand or fly ash. In order to transport the heavy solids, a viscosity enhancer such a bentonite clay is added. Also, friction reducers and “super-plasticizers”, like sulfonated naphthalene, are added to make the slurry pumpable. Although these grouts seem to work well in testing, there are problems with some field installations. The mixture can be expensive to handle, difficult to mix, even more difficult to pump, and extremely rough on equipment because of abrasion. In addition, placing of the material in the borehole is difficult to control and monitor. If grouting is attempted from the surface, “bridging” can occur resulting in a partially filled hole. If grouting from the bottom of the hole, “channeling” can occur, again resulting in a partially grouted hole. When the water subsides in the borehole, this leaves air spaces, thus insulating the loop and reducing the efficiency of the system. An additional disadvantage is that the voids from channeling as well as the interstitial spacing between the individual sand (or other solid particles) can create permeability. Permeability that creates a vertical communication path by which the ground water system could be contaminated by surface spills is an environmental concern.

Certain prior art cementitious grouts, developed to overcome the permeability objection, have some unique problems of their own. In addition to all of the handling, mixing, pumping, abrasion, and conductivity problems of the High Solids Thermally Conductive Grouts, the “heat of hydration” generated when cement cures, causes grout to “shrink” away from the polyethylene pipe. As heat is generated, the polyethylene pipe, having a very high coefficient of expansion, expands. Once the cement cures and cools, the polyethylene contracts and actually pulls away from the grout. Although the permeability of the cured grout itself is very low, a flow path may now exist between the polyethylene pipe and the grout—again insulating the loop and threatening the environment. Because of its inherent structure, polyethylene is a very high molecular weight wax or paraffin, and does not bond well with anything, even under laboratory controlled conditions. Attempts to control grout shrinkage and cement to polyethylene bonding in the field were proven difficult, inadequate or unsuccessful.

Drilling “polymers” have existed for years. They have been used in the oil well drilling industry as an alternative to bentonite clays to provide solids transport, solids suspension, friction reduction, and displacement efficiency.

The prior art discloses a variety of systems and apparatuses for installing ground heat exchange pipe loops in a wellbore, including a system in which a wellbore is drilled, e.g. a vertical hole four to four-and-a half inches in diameter to a depth of about 250 feet, and a single piece of polyethylene pipe attached to a sinker bar is introduced into the hole and then pulled out of the hole manually while grout is introduced into the hole. A pipe loop (polyethylene) is pushed to the bottom of the hole by a wire-line retrievable sinker bar. With the sinker bar removed, a series of screwed together 2 inch PVC tremmie pipes is lowered to the bottom of the hole and grout mixed at the surface is pumped into the tremmie pipe. As each batch is pumped into the hole the tremmie pipe string is raised and one 20 foot section of pipe is removed from the hole. After grouting is completed and the tremmie pipe is removed, the rig is moved to another drilling position, e.g. at least 15 feet away. When all of the pipe loops have been installed (e.g. one loop for each ton of heating and cooling equipment), the drill rig is removed from the site. A trench (e.g. about four feet deep) is then dug to contain pipes that interconnect all of the pipe loops and a connecting pipe is laid into the trench, heat fused to each of the vertical pipe loops, and pressure tested and buried to serve as a circulating manifold carrying water between the earth and a heat pump located within an adjacent building. The trenching and manifolding of the surface pipe typically takes as much time as the wellbore drilling and pipe installation.

The prior art discloses numerous in-ground heat exchanger systems; and grouting systems (see, e.g. U.S. Pat. Nos. 5,435,387; 5,244,037; 5,261,251; 5,590,715; 5,758,724; and 6,276,438)—all of which patents and all references cited therein are incorporated here fully for all purposes.

One prior art filler material uses polymers designed to molecularly bond with water . This molecular bonding increases the viscosity of the fluid, enabling the fluid to carry heavy particles and also prevent loss of circulation. Thus the filler material is a molecularly bonded gel. Bentonite and other drilling clay additives perform the same function, but by creating a colloidal suspension, not a molecularly bonded gel. Consequently, the bentonite may eventually settle out and separate from the water and the water may eventually be lost from the borehole. However, in one aspect the molecular bond between the polymer, e.g., but not limited to xanthan gum, and the water molecule can remain indefinitely. In one aspect the polymer is chemically stabilized with a biocide. In certain embodiments in very high concentrations, a xanthan gum/water mixture consists of at least 97% water, and the thermal conductivity is substantially the value of water. It is also nonpermeable. Such a gelled filler material is pumpable with less friction than pure water. Having no abrasives, there is little or no wear and tear on pumping equipment, and the material's density is very nearly that of pure water. This low specific gravity, along with high surface tension and viscosity reduces or eliminates the buoyancy of a heat loop. In one aspect, such a material is an aqueous stabilized 3% solution of xanthan gum which is less expensive to make than many thermally conductive grouts or cementitious grouts. Pouring three quarts of xanthan biopolymer in a barrel (42 gallons) of water makes a 3% solution.

Certain embodiments of the grout mixtures of U.S. Pat. No. 6,251,179 lack the plasticity qualities needed to prevent small diameter “tremmie” pipes from plugging. These grouts depend heavily on the particle size distribution of the sand to ensure pumpability. Plugging of coil-tubing pipe during grouting with such grouts can be a significant problem resulting in significant lost production and quality issues. Plasticity in a sand grout is a complex factor. It is strongly influenced by the grout's ability to retain water when pressed against a permeable surface. In drilling mud technology this factor is called fluid loss. A grout with poor fluid loss control can undergo a slight separation of fluid from the sand as it travels through the pipe. Sand movement along the pipe wall can cause friction, which slows the sand down and creates a differential pressure across the front of grout moving down the pipe. This differential pressure can cause the fluid portion of the grout to move ahead of some of the sand. The reduction in fluid to sand ratio in the grout behind this front then causes the grout to bridge and pack off in the pipe. Generally the pumping pressure will quickly rise to the limit of the equipment or the pipe. The tremmie pipe can rupture from the high pressures from the positive displacement grout pump. In any case, once plugging has occurred, the tremmie pipe often must be extracted from the well and repaired, cleaned out, or abandoned. Grouts that have poor plasticity and fluid loss control are also not efficient at displacing mud and water from the annular space between the heat transfer loop pipes and the borehole.

There has long been a need for: a grout that overcomes the problems of the prior art grouts; and an efficient highly thermally conductive, factory engineered and pre-packaged, cementitious grout product that is easily and consistently pumpable over long distances through small diameter tremmie pipes.

### SUMMARY OF THE PRESENT INVENTION

The present invention in at least certain embodiments provides a grout material for use in earth loop heat exchange systems that in certain aspects is a pre-blended dry grout mixture blended, preferably, with a specific ratio of water on the work site to produce a highly plastic grout material which is pumpable through tubulars, e.g., but not limited to, through hundreds of feet of one-inch diameter coil tubing tremmie pipe with reduced plugging or without plugging the tubing or requiring excessive pressure. To achieve low cost and minimum shrinkage the majority of the grout—e.g., from fifty to eighty percent by weight—is sand, e.g., but not limited to, naturally occurring silica sand preferably having an un-graded size distribution that is lower in cost than graded material. Any suitable cement may be used, including, but not limited to, ASTM or API cement grade (including mixtures of these with ground granulated blast furnace slag which helps to avoid an alkali metal silicate reaction); and, in certain aspects, Type I or II Portland cement is used. In certain aspects, the sand to cement ratio is between approximately 1:1 and 4:1 by dry weight and in one particular embodiment is approximately 2:1. In certain particular embodiments, a cement friction reducing agent such as commercially available “D-Charge” from the M-I Drilling Fluids of Houston, Tex., is added in an amount ranging from 0.3 to 2 parts by dry weight. This friction-reducing additive creates a repelling electrostatic charge on the cement particles in the resulting slurry in a fluid friction and viscosity decrease. Cement retarding admixtures, such as sodium or calcium lignosulfonate, may, optionally, be added in an amount sufficient to give 1 to 24 hours of set delay. A long chain polysaccharide xanthan gum additive such as commercially available “DuoVis” may be added in an quantity ranging from 0.0001 to 0.0020 parts by dry weight to reduce pumping friction. Water is added in a range of 10 to 20 percent of the weight of the dry grout. Bentonite clay (sodium montmorillinite) in an amount from 6 percent to 20 percent of the weight of the water or 1 to 5 percent of the weight of the dry grout components may, optionally, be added to increase plasticity for fluid loss control. In certain preferred grout formulations according to the present invention, the sand and cement make up about 98 percent of the dry grout mixture, while some of the lesser components, such as the long chain polysaccharide xanthan gum, account for as little as 0.05 percent. Such grout may be used in any of the systems of U.S. Pat. Nos. 5,758,724; 6,041,82; 5,590,715; and 6,276,438—all of which are incorporated fully herein for all purposes.

With certain grouts according to the present invention, plasticity is increased and friction is reduced to enhance pumping characteristics. Certain grouts according to the present invention have an relatively long set time which reduces the maintenance of the grouting equipment and the reduces the severity of plugging of pipe and equipment by set grout.

The present invention discloses, in certain aspects, a wellbore heat loop system and methods for transferring heat, the systems in certain aspects including a heat loop wellbore in the earth extending from an earth surface down into the earth to a bottom of the wellbore, a heat loop (or loops) disposed in the heat loop wellbore and extending down to a desired depth, the heat loop made of suitable tubular(s) or heat loop pipe, and grout as described herein according to the present invention around the heat loop(s) in the wellbore.

What follows are some of, but not all, the objects of this invention. In addition to the specific objects stated below for at least certain preferred embodiments of the invention, other objects and purposes will be readily apparent to one of skill in this art who has the benefit of this invention's teachings and disclosures. It is, therefore, an object of at least certain preferred embodiments of the present invention to provide:

New, useful, unique, efficient, nonobvious grout filler materials for the annular space between the exterior of earth loops and the earth itself in the wellbores of such systems for enhancing energy transfer from the earth to fluid circulation in the earth loops, in one aspect, earth energy transfer loop systems with such grout;

Such grout filler materials with a relatively long set time;

Such grout filler materials which are at least half silica sand by weight;

Such grout filler materials with increased plasticity and reduced friction; and

New, useful, unique, efficient, nonobvious devices and methods for systems and methods for installing heat exchange pipe loops in wellbores.

Certain embodiments of this invention are not limited to any particular individual feature disclosed here, but include combinations of them distinguished from the prior art in their structures and functions. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

The present invention recognizes and addresses the previously-mentioned problems and long-felt needs and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later disguise it by variations in form or additions of further improvements.

### DESCRIPTION OF EMBODIMENTS PREFERRED AT THE TIME OF FILING FOR THIS PATENT

The present invention discloses in certain aspects a dry grout mixture which is blended with known blending apparatus. In one aspect the grout according to the present invention at least half sand by weight and in one particular aspect is about two-thirds by weight sand and about one-third by weight cement. With such an amount of sand cost is kept at a minimum (as compared to grouts with a relatively higher ratio of cement) and shrinkage is reduced or minimized. In this embodiment the sand is, preferably, naturally occurring silica sand with an un-graded size distribution that is lower in cost than graded material. Although any suitable cement may be used, including but not limited to any ASTM or API cement grade (including mixtures of these with ground granulated blast furnace slag which helps to avoid an alkali metal silicate reaction), in one preferred embodiment Type I or II Portland cement is preferred and the sand to cement ratio is approximately 2:1 by dry weight. Water is added in a range of 12 to 19 percent of the weight of the dry grout.

In certain embodiments a cement friction reducing agent such as “D-Charge”, is added in an amount ranging from 0.3 to 2 parts by dry weight. This friction-reducing additive creates a repelling electrostatic charge on the cement particles in a resulting sand/cement/water slurry that decreases fluid friction.

In certain aspects cement setting retardant materials, such as, but not limited to, sodium or calcium lignosulfonate, are added in an amount sufficient to give 1 to 24 hours of set delay. A long chain polysaccharide xanthan gum additive, e.g., “DuoVis.” may be added in a quantity ranging from 0.0001 to 0.0020 parts by dry weight to reduce pumping friction. Bentonite clay (sodium montmorillinite) in an amount from 6 percent to 20 percent of the weight of the water or 1 to 5 percent of the weight of the dry grout components may be added to increase plasticity for fluid loss control (to control loss of fluid from the mixture during pumping which could result in sand bridging in the mixture and plugging of the tremmie pipe).

In one embodiment, the sand and cement make up about ninety-eight percent of the dry grout mixture, while some of the lesser components, such as the long chain polysaccharide xanthan gum, account for as little as 0.05 percent.

In order to insure a correct mix ratio for various components, certain components (e.g, the friction reducing agent; cement setting retardant; and/or pumping friction reducer) may be pre-blended off site and/or at an area or facility remote from the site of a wellbore in which they will be used. Such components may be packaged in small individual sacks or containers, which are sized to offer the correct volume proportion for a secondary blending operation—an operation that dry-blends the sand and cement with the other components and which may, in certain aspects, be done on site. In one such embodiment, one bag of an admixture of friction reducing agent, cement setting retardant, and pumping friction reducer (approximately 62 pounds total) is factory blended off-site and then this bag is blended, either on-site or off-site, with one batch mix (approximately 3,000 pounds) of the major components, sand and cement. This reduces human error in mixing the components and achieves high quality in mix proportioning. In one aspect, large bags, containers, or sacks of about 3,000 pounds of the resulting grout, with all components thoroughly mixed together, are shipped to a jobsite where water is the only ingredient to be field measured and added.

In one aspect a cementitious grout according to the present invention has sand and cement, with sand-to-cement in a range of ratios from 1:1 to 4:1, by weight; optionally, a cement friction reducing admixture in a ratio of about 0.008:1 to about 0.04:1 by weight to the cement and sand; water in a ratio of from about 0.1 to 0.2 by weight of the sand and cement; and, optimally, bentonite in a ratio of from about 5.1 percent to about 20 percent by weight of the water.

In one aspect, a sand and cement grout according to the present invention has, by dry weight, 45 to 75 percent sand, 25 to 45 percent cement, 1 to 4 percent bentonite, and water added in a ratio of 12 to 20 percent of the dry weight. Such a grout may also have cement friction reducing additives which create a repelling electrostatic charge on the particles in the slurry resulting in a fluid friction decrease.

In one aspect, a dry grout blend according to the present invention has 50 to 75 percent sand, 25 to 44 percent Portland cement, and 1 to 5 percent bentonite clay. In one aspect such dry grout blend has a friction-reducing admixture made from a polysaccharide Xanthan gum; a cement friction reducer condensate, which reduces cement friction by creating an electrostatic charge; a spray dried sodium lignosufonate; a foam-reducing additive, e.g., but not limited to, steric acid, a petroleum derivative,.e.g, by weight one half to two percent; and/or is packaged in bags of 1000 to 4000 pounds of the grout. It is within the scope of the present invention to manufacture a dry grout by blending a sand and cement with a pre-blended bag of such a dry admixture.

The present invention provides, in certain embodiments, improvements of grouts disclosed in U.S. Pat. No. 6,251,179 which is incorporated fully herein for all purposes. In one aspect a grout according to the present invention is a thermally conductive cement-sand grout for use with a geothermal heat pump system, the cement sand grout containing cement, silica sand, optionally a superplasticizer, water, optionally bentonite and: a cement friction reducer condensate, which reduces cement friction by creating an electrostatic charge; a calcuim or sodium lignosufonate, in one aspect spray dried sodium lignosulfonate; and a foam-reducing additive. The present invention also includes a method of filling boreholes used for geothermal heat pump systems with this thermally conductive cement-sand grout. In other aspects, this grout includes: a cement; a silica sand in a ratio of from 1:1 to about 4:1 on a weight basis to the cement; optionally bentonite; optionally, a superplasticizer in a ratio of from about 0.0005:1 to about 0.03:1 on a weight basis to the cement and sand; water in a ratio of from about 0.2:1 to about 2:1 on a weight basis to the sand and cement; and optionally, a cement friction reducer condensate, which reduces cement friction by creating an electrostatic charge; a calcium lignosulfonate or a sodium lignosulfonate, in one aspect, spray dried sodium lignosulfonate; and a foam-reducing additive. In another aspect a grout according to the present invention has from about 15 to about 40 weight percent cement; from about 5 to about 25 weight percent water; optionally from about 0.1 to about 2 weight percent bentonite; from about 40 to about 75 weight percent sand; optionally, from about 0.1 to about 2 weight percent sulfonated naphthalene superplasticizer; and optionally, a cement friction reducer condensate, which reduces cement friction by creating an electrostatic charge; a spray dried sodium lignosulfonate; and a foam-reducing additive. The present invention provides a method of filling boreholes used with a geothermal heat pump system, the method including providing a hole in the ground; inserting an earth loop, e.g., but not limited to, a U-loop in said hole; contacting said loop with a cementitious grout having a cement, water, a silica sand, optionally bentonite, a superplasticizer, and a cement friction reducer condensate, which reduces cement friction by creating an electrostatic charge; a spray dried sodium lignosulfonate; and a foam-reducing additive; and curing said grout.

The present invention, in certain embodiments, discloses a grout for use in a borehole of an earth energy transfer system between the exterior of an earth loop in the borehole and an interior wall of the borehole, the system having an energy transfer fluid moving through the loop for transferring energy with respect to the earth, the grout including sand, cement, the cement present in particles, water, and material creating a repelling electrostatic charge on cement particles for reducing friction of the grout. Such a grout may have any one or some (in any possible combination) of the following: wherein by weight the sand is present in a ratio to between 1:1 and 4:1 and the water is present at about 0.1 to 0.2 of combined sand and cement; further including bentonite and, in certain aspects, wherein the bentonite is present by weight as about 5.1% to about 20% of the water; wherein by dry weight sand is present as 45% to 75% of the sand, cement and bentonite, cement is present as 25% to 45% of the sand, cement and bentonite, and bentonite is present as 1% to 4% of the sand, cement and bentonite; wherein water is added by weight as 12% to 20% of combined dry weight of sand, cement, and bentonite; wherein the cement is Portland cement, the sand is present by dry weight as 50% to 75% of combined sand, cement, and bentonite, the cement is present as 25% to 44% of combined sand, cement, and bentonite, and the bentonite is present as 1% to 5% of combined sand, cement, and bentonite; wherein by weight the material creating a repelling electrostatic charge on cement particles is present in a ratio to combined sand and cement between 0.008:1 and 0.04:1; superplasticizer material; wherein by weight a ratio of the superplasticizer material to combined sand and cement is between 0.008 to 1 and 0.040 to 1; wherein the superplasticizer material is from the group consisting of sulfonated naphthalene formaldehyde condensate and sulfonated melamine formaldehyde condensate; cement setting retardant effective for retarding setting of the cement, and certain aspects, wherein by weight a ratio of the cement setting retardant to combined sand and cement is between 0.008 to 1 and 0.040 to 1; wherein the cement setting retardant is from the group consisting of calcium lignosulfonate and sodium lignosulfonate; wherein the sodium lignosulfonate is spray-dried sodium lignosulfonate; foam-reducing material effective for reducing foam in the grout; and/or wherein the foam-reducing material by weight is present as between 0.5% and 2.0% of the grout.

The present invention, in certain embodiments, provides a dry grout blend for use in a borehole of an earth energy transfer system between the exterior of an earth loop in the borehole and an interior wall of the borehole, the system having an energy transfer fluid moving through the loop for transferring energy with respect to the earth, the grout including sand, Portland cement, and bentonite. Such a dry grout blend may have one or some (in any possible combination) of the following: friction reducing material; cement setting retardant material, in one aspect, cement setting retardant from the group consisting of sodium lignosulfonate and calcium lignosulfonate, and in one aspect wherein the cement setting retardant is spray-dried sodium lignosulfonate; and/or foam-reducing material effective for reducing foam in the grout.

The present invention, in certain embodiments, provides an amount of components for adding to a mixture of sand and cement, the amount including friction reducing agent, cement setting retardant, and pumping friction reducer; and, optionally, foam-reducing additive.

The present invention, in certain embodiments, provides a method for making a grout, the method including mixing sand, cement and an amount of components, the amount of components mixed together prior to the mixing of the sand and cement and the amount of components provided in a container for addition therefrom to the sand and cement, the amount of component having friction reducing agent, cement setting retardant, and pumping friction reducer.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to all equivalent elements or steps. The following claims are intended to cover the invention as broadly as legally possible in whatever form it may be utilized. The invention claimed herein is new and novel in accordance with 35 U.S.C. §102 and satisfies the conditions for patentability in §102. The invention claimed herein is not obvious in accordance with 35 U.S.C. §103 and satisfies the conditions for patentability in §103. This specification and the claims that follow are in accordance with all of the requirements of 35 U.S.C. §112. The inventors may rely on the Doctrine of Equivalents to determine and assess the scope of their invention and of the claims that follow as they may pertain to apparatus not materially departing from, but outside of, the literal scope of the invention as set forth in the following claims.

What is claimed is:

1. A grout for use in a borehole of an earth energy transfer system between the exterior of an earth loop in the borehole and an interior wall of the borehole, the system having an energy transfer fluid moving through the loop for transferring energy with respect to the earth, the grout comprising
sand,
cement, the cement present in particles,
water, and
material creating a repelling electrostatic charge on cement particles for reducing friction of the grout.

2. The grout of claim 1 wherein by weight
the sand is present in a ratio to between 1:1 and 4:1 and the water is present at about 0.1 to 0.2 of combined sand and cement.

3. The grout of claim 1 further comprising bentonite.

4. The grout of claim 3 wherein the bentonite is present by weight as about 5.1% to about 20% of the water.

5. The grout of claim 4 wherein by dry weight
sand is present as 45% to 75% of the sand, cement and bentonite,
cement is present as 25% to 45% of the sand, cement and bentonite, and
bentonite is present as 1% to 4% of the sand, cement and bentonite.

6. The grout of claim 5 wherein water is added by weight as 12% to 20% of combined dry weight of sand, cement, and bentonite.

7. The grout of claim 4 wherein the cement is Portland cement, the sand is present by dry weight as 50% to 75% of combined sand, cement, and bentonite; the cement is present as 25% to 44% of combined sand, cement, and bentonite; and the bentonite is present as 1% to 5% of combined sand, cement, and bentonite.

8. The grout of claim 1 wherein by weight the material creating a repelling electrostatic charge on cement particles is present in a ratio to combined sand and cement between 0.008:1 and 0.04:1.

9. The grout of claim 1 further comprising
superplasticizer material.

10. The grout of claim 1 wherein by weight a ratio of the superplasticizer material to combined sand and cement is between 0.008 to 1 and 0.040 to 1.

11. The grout of claim 1 wherein the superplasticizer material is from the group consisting of sulfonated naphthalene formaldehyde condensate and sulfonated melamine formaldehyde condensate.

12. The grout of claim 11 further comprising cement setting retardant effective for retarding setting of the cement.

13. The grout of claim 1 wherein by weight a ratio of the cement setting retardant to combined sand and cement is between 0.008 to 1 and 0.040 to 1.

14. The grout of claim 11 wherein the cement setting retardant is from the group consisting of calcium lignosulfonate and sodium lignosulfonate.

15. The grout of claim 14 wherein sodium lignosulfonate is spray-dried sodium lignosulfonate.

16. The grout of claim 1 further comprising
foam-reducing material effective for reducing foam in the grout.

17. The grout of claim 14 wherein the foam-reducing material by weight is present as between 0.5% and 2.0% of the grout.

18. A dry grout blend for use in a borehole of an earth energy transfer system between the exterior of an earth loop in the borehole and an interior wall of the borehole, the system having an energy transfer fluid mooing through the loop for transferring energy with respect to the earth, the grout comprising
sand,
Portland cement, and bentonite.

19. The dry grout blend of claim 18 further comprising friction reducing material.

20. The dry grout blend of claim 18 further comprising cement setting retardant material.

21. The dry grout blend of claim 20 wherein the cement setting retardant is from the group consisting of sodium lignosulfonate and calcium lignosulfonate.

22. The dry grout blend of claim 21 wherein the cement setting retardant is spray-dried sodium lignosulfonate.

23. The dry grout blend of claim 18 further comprising foam-reducing material effective for reducing foam in the grout.

24. An amount of components for adding to a mixture of sand and cement, the amount comprising
friction reducing agent,
cement setting retardant, and
pumping friction reducer.

25. The amount of components of claim 24 further comprising
foam-reducing additive.

26. A method for making a grout, the method comprising
mixing sand, cement and an amount of components, the amount of components mixed together prior to the mixing of the sand and cement and the amount of components provided in a container for addition therefrom to the sand and cement, the amount of component comprising friction reducing agent, cement setting retardant, and pumping friction reducer.

27. Any invention disclosed herein.
